(19) United States
(12) Patent Application Publication
(10) Pub. No.: US 2009/0272861 A1
(43) Pub. Date: Nov. 5, 2009

(54) SAW HORSE BRACKET

(76) Inventor: Phillip Bevelacqua, Newaygo, MI (US)

Correspondence Address: ROBERT J. SAYFIE, P.C., 161 OTTAWA AVENUE NW, SUITE 407, GRAND RAPIDS, MI, 49503, US

(21) Appl. No.: 12/114,094

(22) Filed: May 2, 2008

(51) Int. Cl. F16M 11/16

(52) U.S. Cl. 248/188

(57) ABSTRACT

A saw horse bracket, comprising: a face oriented in a substantially vertically; a support extending perpendicularly forwardly from the face; the support oriented substantially horizontally, the support having a support aperture; a top extending perpendicularly rearwardly from the face; the top disposed upwardly from the support, the top oriented substantially horizontally; a first side extending forwardly from the face, the first side oriented substantially vertically, the first side having a first side aperture; a second side extending forwardly from the face, the second side oriented substantially vertically, the second side disposed rightwardly of the first side, the second side having a second side aperture; and an overhang extending downwardly from the top, the overhang oriented substantially vertically, the overhang disposed rearwardly from the face, the overhang (60) having an overhang aperture.

### CROSS-REFERENCE TO RELATED APPLICATION

This application claims priority under 35 U.S.C. §119(e) to U.S. Provisional Patent Application No. 601/928,654 filed on 4 May 2007.

### GOVERNMENT RIGHTS

This invention was not made with Government support under. The Government does not have any rights in this invention.

### BACKGROUND OF THE INVENTION

Tables exist for many purposes. The horizontal surfaces that tables generally provide are used for work surfaces, eating surfaces, and game playing surfaces.

Sawhorses are generally used at worksites to set things on and of course to set boards such as 2×4's across for sawing.

In many instances, someone in possession of sawhorses wants to make a flat surfaced table. In constructing a table, a rectangular shaped piece of plywood or door is typically nailed from the top to the saw horse. After time and continued use, the saw horse gains an increased number of nail holes; and can no longer be used to make a table-type working surface, or its several holes can impair it use as a sawhorse. The table can be used on a construction site to hold heavy tools. To disassemble the table, the door or plywood must be removed, which leaves holes in the beams.

A sawhorse is typically a beam with four supports or legs used to support a board or plank for sawing. A scaffold can be formed by placing two sawhorses that are close in proximity to support a board or plank to stand on.

The sawhorse may be connected to the beam with a hinged member so that it can fold for storage.

Construction sites typically contain saw horses; spare 2×4's, nails and hammers. At such a worksite, constructing a stable work surface, platforms, or scaffolding involves securing some cross beams to the saw horses by nailing them in, and then nailing a piece of plywood to the cross beams and/or the saw horses; however the cross beams that are nailed to the saw horse beams are only held by nails hammered through the saw horse beam to the cross beam. Thus the nails enter the cross beam longitudinally, which subjects them to cracking, fracture, and creates a work surface of limited load capacity.

Further, while two saw horses, two 2×4's, a sheet of plywood, and some nails can make a work surface, any movement, strong winds, hammering, sawing, vibration, or other tension or compression tends to move the 2×4 cross beams with respect to the saw horse beam to which they may be nailed, which causes the assembly to fall apart.

Alternatives include bringing tables to a worksite.

As can be seen, there is a need for a quick and easy way to construct a table from a pair of sawhorses that does not place large hole in the tops of the beams of the sawhorse. There is also a need to create a stable work surface without carrying several different items to a work site to use for the assembly of the table or work surface. There is also a need to easily construct a stable working surface by only bringing a small amount of extra equipment, such that the extra equipment may be transported in a coat pocket, or even pants pocket, such as four small brackets.

### SUMMARY OF THE INVENTION

One aspect of the present invention comprises a saw horse bracket, comprising: a face (20) oriented in a substantially vertically; a support (70) extending perpendicularly forwardly from said face (20); said support (70) oriented substantially horizontally, said support (70) having a support aperture (110); a top (50) extending perpendicularly rearwardly from said face (20); said top (50) disposed upwardly from said support (70), said top oriented substantially horizontally; a first side (30) extending forwardly from said face (20), said first side (30) oriented substantially vertically, said first side (30) having a first side aperture (90); a second side (40) extending forwardly from said face (20), said second side (40) oriented substantially vertically, said second side (40) disposed rightwardly of said first side (30), said second side (40) having a second side aperture (100); and an overhang (60) extending downwardly from said top (50), said overhang (60) oriented substantially vertically, said overhang (60) disposed rearwardly from said face (20), said overhang (60) having an overhang aperture (80).

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is a different pictorial view of an embodiment of the present invention;

FIG. 3 is a pictorial showing the bracket on a sawhorse; and

FIG. 4 is another pictorial showing the bracket on a sawhorse.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Reference numerals:

10 table bracket

20 face

21 face inside surface

22 face lower edge

24 face upper edge

26 face first edge

28 face second edge

30 first side

40 second side

41 first side and second side distance

50 top

60 overhang

61 overhang inside surface

70 support

80 overhang aperture

90 first side aperture

100 second side aperture

110 support aperture

120 top-overhang angle

130 face-support angle

140 face-top angle

200 saw horse beam

210 saw horse

300 panel

400 cross beam

Certain terminology will be used in the following description for convenience and reference only, and will not be limiting. For example, the words “upwardly,” “downwardly,” “rightwardly” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words.

The present invention allows for the assembly, construction, and disassembly of a solid work surface or table.

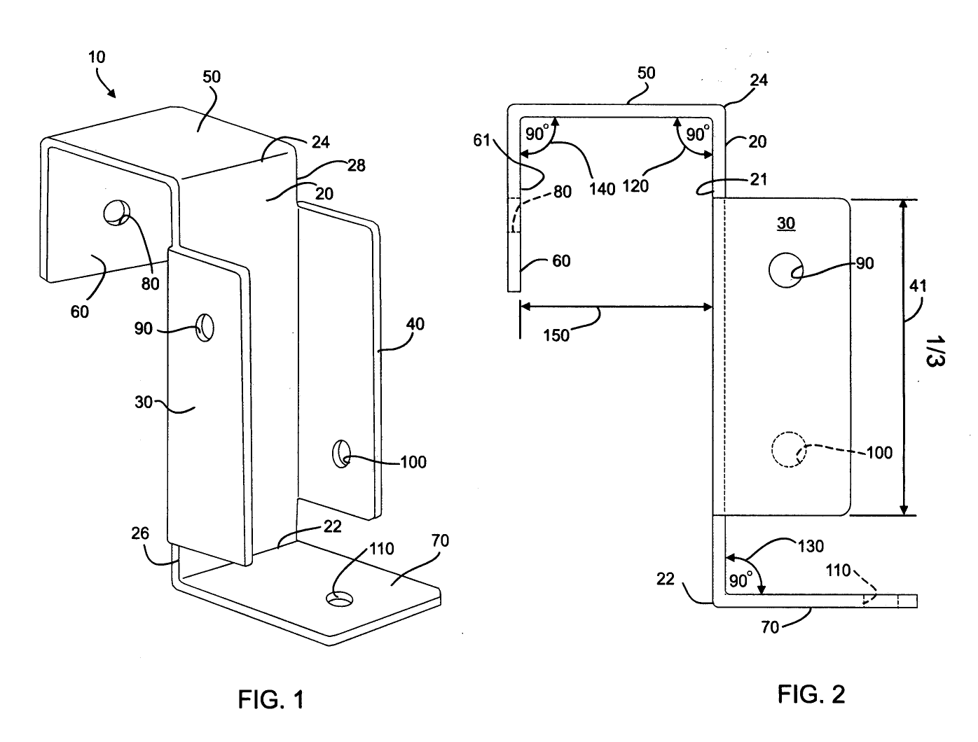

FIG. 1 illustrates one embodiment on the present invention. A support 70 is provided. The support 70 may be a four sided geometric figure oriented substantially horizontally when in use. A face 20 may extend upwardly and perpendicularly from the support 70. The face 20 may be oriented substantially vertically when the support 70 is oriented substantially horizontally.

The face 20 may be bound by a face lower edge 22, a face upper edge 24 disposed upwardly from the face lower edge 22, a face first edge 26 between the face lower edge 22 and the upper edge 24, and a face second edge 28 disposed rightwardly from the face first edge 26. The support 70 may extend perpendicularly away from a face lower edge 22. A top 50 may extend substantially perpendicularly away from the face upper edge 24 in the direction opposite the support 70, referred to herein as the rearwardly direction, so that the top 50 is substantially parallel with the support 70. Thus the face lower edge 22 may be substantially parallel with the face upper edge 24; and the face first edge 26 may be substantially parallel with the face second edge 28.

An overhang 60 may extend substantially downwardly and perpendicularly from the top 50 so that the overhang 60 is substantially parallel with the face 20; and the top 50 is substantially parallel with respect to the support 70. A first side 30 may extend perpendicularly away from and forwardly from the face first edge 26. A second side 40 may extend perpendicularly and forwardly from the face second edge 28, so that the second side 40 is substantially parallel with the first side 30. As seen in FIG. 1, the first side 30 and second side 40 may be oriented vertically when the top 50 and support 70 are oriented horizontally.

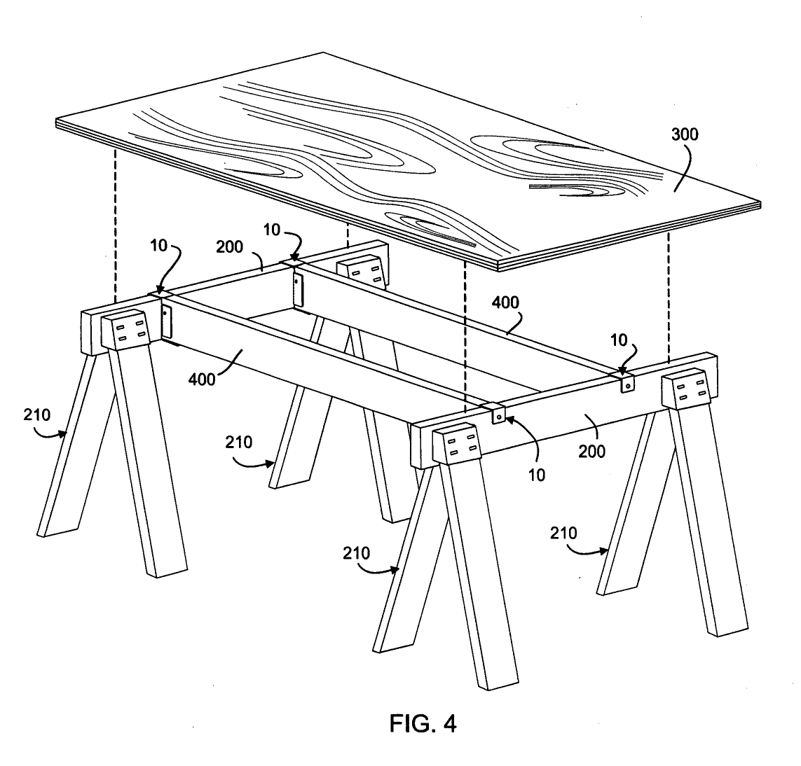

FIG. 1 further illustrates that the overhang 60 may have a overhang aperture 80, which may be capable of receiving a nail so that the saw horse bracket 10 may be nailed to the beam 200 (as illustrated in FIG. 3) of a saw horse. The first side 30 may have a first side aperture 90, which may be capable of receiving a nail, so that the saw horse bracket 10 may be nailed to a cross beam 100 (as illustrated in FIG. 3). The second side 40 may have a second side aperture 100, which may be capable of receiving a nail, so that the saw horse bracket 10 may be secured or nailed to a cross beam 100 (as illustrated in FIG. 3). The support 70 may have a support aperture 110, which may be capable of receiving a nail, so that the saw horse bracket 10 may be nailed or secured to a cross beam 100 (as illustrated in FIG. 3). The first side 30 may be about 1 17/32 inches from the second side 40.

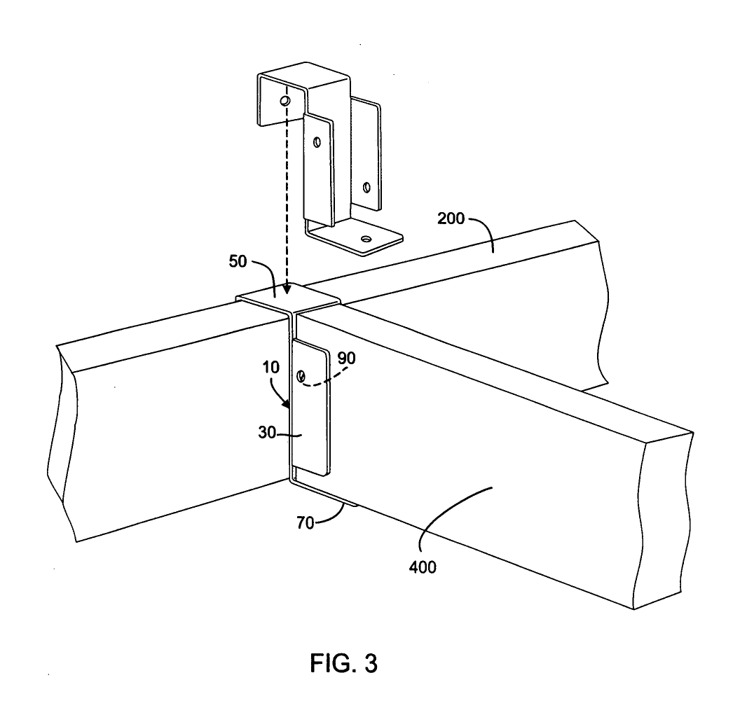

FIG. 2 illustrates that a top-overhang angle 120 may be about 90°; and a face-support angle 130 may be about 90°; and a face-top angle 140 may be about 90°. In one embodiment the distance from the face 20 and the overhang 60 may be such that a 1½ inch piece of wood may fit between the face 20 and the overhang 60. In one embodiment a face inside surface 21 may be about 1 17/32 inches from an overhang inside surface 61.

FIG. 3 illustrates the saw horse bracket 10 connected to a saw horse beam 200 and a cross beam 400.

FIG. 4 illustrates the present invention saw horse bracket 10 as it is placed on a beam of a saw horse. A flat panel, such as a piece of plywood 300 is illustrated above the saw horse bracket 10, so that one can see how a pair of saw horse brackets 10 may be used to secure cross-beams 100 to the saw horse bracket 10; and secure the saw horse bracket 10 to the beams 200 of the saw horse 210.

In one embodiment the support 70 may extend from the face 20 by about 1⅜ inches and the support aperture 110 may be anywhere; but in one embodiment the support aperture 100 may be disposed about 1⅛ inches from the face 20. The first side 30 may extend about 1 1/16 inches from the face 20. The first side aperture 90 may be disposed just about anywhere on the first side 30. In one embodiment the first side aperture 90 and second side aperture 100 may each be about 0.8125 inches from the face 20.

The first side aperture 90 may be offset with respect to the second side aperture 100, so that the center point of each aperture does not coincide. The overhang aperture 80 may anywhere on the overhang; but in one embodiment, it may be about ¾ inches below the top 50.

In one embodiment each aperture; the overhang aperture 80, the first side aperture 90, the second side aperture 100, and the support aperture may be about 5/32 inches in diameter.

In one embodiment the vertical distance from the top 50 to the support 70 may be about 3½ inches. In one embodiment the first side 30 and second side 40 may have a first side and second side vertical distance 41 of about 2¼ inches. Thus the first side 30 and second side 40 may be disposed about ⅝ inches downwardly from the top 50, and about ⅝ inches upwardly from the support 70.

In one embodiment, the saw horse bracket 10 may be made from 14 gage steel; however other materials may also be suitable.

Thus, with four of the saw horse brackets 10, two saw horses 210, two cross beams 400, and a piece of plywood 300, and 16 nails, a stable working surface may be constructed.

It should be understood, of course, that the foregoing relates to exemplary embodiments of the invention and that modifications may be made without departing from the spirit and scope of the invention as set forth in the following claims.

We claim:

1. A saw horse bracket, comprising:
a face (20) oriented in a substantially vertically;
a support (70) extending perpendicularly forwardly from said face (20); said support (70) oriented substantially horizontally, said support (70) having a support aperture (110);
a top (50) extending perpendicularly rearwardly from said face (20); said top (50) disposed upwardly from said support (70), said top oriented substantially horizontally;
a first side (30) extending forwardly from said face (20), said first side (30) oriented substantially vertically, said first side (30) having a first side aperture (90);
a second side (40) extending forwardly from said face (20), said second side (40) oriented substantially vertically, said second side (40) disposed rightwardly of said first side (30), said second side (40) having a second side aperture (100); and
an overhang (60) extending downwardly from said top (50), said overhang (60) oriented substantially vertically, said overhang (60) disposed rearwardly from said face (20), said overhang (60) having an overhang aperture (80).

2. The apparatus of claim 1, wherein said support (70) is a four sided figure.

3. The apparatus of claim 1, wherein said face (20) is bound by a face lower edge (22), a face upper edge (24) disposed upwardly from said lower edge (22), a face first edge (26) disposed substantially perpendicular to said face upper edge (24) and said face lower edge (22), and a face second edge (28) disposed rightwardly from said face first edge (26), said face second edge (28) disposed substantially parallel with said face first edge (26).

4. The apparatus of claim 1, wherein said support (70) extends from a face lower edge (22).

5. The apparatus of claim 1, wherein said overhang (60) is substantially perpendicular with said face (20).

6. The apparatus of claim 1, wherein said first side (30) is substantially parallel with said second side (40).

7. The apparatus of claim 1, wherein said overhang (60) extends substantially downwardly and perpendicularly from said top (50) so that the overhang (60) is substantially parallel with said face (20), and said top (50) is substantially parallel with said support (70).

8. The apparatus of claim 3, wherein said first side (30) extends from said face first edge (26), and said second side (40) extends from said face second edge (28), and said top (50) extends from said face upper edge (24), and said support (70) extends from said face lower edge (22).

9. The apparatus of claim 1, wherein at least one of the overhang aperture (80), first side aperture (90), second side aperture (100), and support aperture (110) is capable of receiving a nail therethrough.

10. The apparatus of claim 1, wherein said first side (30) is about 1 17/32 inches from said second side (40).

11. The apparatus of claim 1, wherein said support (70) extends from said face (20) by about 1⅜ inches.

12. The apparatus of claim 1, wherein said support aperture (100) is disposed about 1⅛ inches from said face (20).

13. The apparatus of claim 1, wherein at least one of said first side aperture (90) and said second side aperture (100) is about 0.8125 inches from said face (20).

14. The apparatus of claim 1, wherein said first side aperture (90) is offset with respect to said second side aperture (100).

15. The apparatus of claim 1, wherein said overhang aperture (80) is disposed about ¾ inch downwardly from said top.

16. The apparatus of claim 1, wherein at least one of the overhang aperture (80), first side aperture (90), second side aperture (100), and support aperture (110) has a diameter of about 5/32 of an inch.

17. The apparatus of claim 1, wherein a vertical distance from said top (50) to said support (70) is about 3½ inches.

18. The apparatus of claim 1, wherein said first side (30) and said second side (40) are about 2¼ inches in length, measured vertically, and disposed about ⅝ inch downwardly from said top (50).
